(19) United States
(12) Patent Application Publication
(10) Pub. No.: US 2012/0085788 A1
(43) Pub. Date: Apr. 12, 2012

(54) Vacuum Cream Container that is Operable by Rotation to Squeeze Cream Outward

(76) Inventor: Yu-Chu Lu, Taichung City (TW)

(21) Appl. No.: 12/900,568

(22) Filed: Oct. 8, 2010

(51) Int. Cl. B67D 7/60

(52) U.S. Cl. 222/390; 222/405

(57) ABSTRACT

A container includes a container body, a rotation seat having a shaft tube, a plurality of limit bars mounted in the shaft tube, a threaded rod having a plurality of limit slots slidably mounted on the limit bars, an inner box having a receiving chamber which has an inner threaded portion screwed onto the threaded rod, a fixing cap having an outlet hole, a piston movably mounted in the receiving chamber and moved by the threaded rod, and an outer cover mounted on the fixing cap. Thus, the cream is compressed by rotation of the rotation seat so that a determined amount of cream is squeezed outward from the fixing cap. In addition, the space between the fixing cap and the receiving chamber is disposed at a vacuum state by the piston to prevent the cream from contacting the ambient air.

### BACKGROUND OF THE INVENTION

1. Field of the Invention

The present invention relates to a container and, more particularly, to a container that contains a cosmetic product, such as cream, lotion, emulsion, moisturizer and the like, to cleanse, whiten, energize or regenerating a user's skin or face.

2. Description of the Related Art

A conventional container comprises a container body having an inner portion provided with a receiving chamber to receive cosmetic cream, and a top cover removably mounted on the container body to cover the receiving chamber of the container body. Thus, the cosmetic cream is received in the receiving chamber of the container body and is cover by the top cover when not in use. When in use, the top cover is removed from the container body to expose the cream in the receiving chamber of the container body so that the user can directly take the cream from the receiving chamber of the container body by her hand. However, the cream directly contacts the ambient air when the top cover is removed from the container body so that the cream is easily decomposed or decayed due to a frequent contact with the ambient air during a long-term utilization. In addition, the user's hand directly touches the cream so that the cream is easily contaminated.

### BRIEF SUMMARY OF THE INVENTION

In accordance with the present invention, there is provided a container, comprising a container body, a rotation seat rotatably mounted on a bottom of the container body and provided with a shaft tube extending into the container body, a plurality of limit bars mounted in the shaft tube of the rotation seat, a threaded rod movably mounted in the shaft tube of the rotation seat and having a periphery provided with an outer threaded portion which has a plurality of limit slots slidably mounted on the limit bars, an inner box mounted on a top of the container body and having an inner portion provided with a receiving chamber which has a bottom provided with an inner threaded portion screwed onto the outer threaded portion of the threaded rod, a fixing cap mounted on an open top of the inner box to seal the receiving chamber of the inner box and having a surface provided with an outlet hole connected to the receiving chamber of the inner box, a piston movably mounted in the receiving chamber of the inner box and connected with the threaded rod to move in concert with the threaded rod relative to the fixing cap, and an outer cover mounted on the fixing cap to cover the outlet hole of the fixing cap.

The primary objective of the present invention is to provide a vacuum cream container that is operable by rotation to squeeze cream outward.

According to the primary advantage of the present invention, the cream is compressed gradually by rotation of the rotation seat so that a determined amount of cream is squeezed outward from the outlet hole of the fixing cap to prevent the cream from being squeezed too excessively and to prevent waste of the cream.

According to another advantage of the present invention, the piston is moved in the receiving chamber of the inner box to compress the cream so that the space between the fixing cap and the receiving chamber of the inner box is disposed at a vacuum state to prevent the cream from contacting the ambient air so as to keep freshness and purity of the cream in the receiving chamber of the inner box.

According to a further advantage of the present invention, the cream is directly squeezed outward from the outlet hole of the fixing cap so that the user's hand will not directly touch the cream to prevent the cream from being contaminated.

According to a further advantage of the present invention, the user only needs to rotate the rotation seat to squeeze the cream outward from the outlet hole of the fixing cap so that the container is operated easily and conveniently.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a container in accordance with the preferred embodiment of the present invention.

FIG. 2 is an exploded perspective view of the container as shown in FIG. 1.

FIG. 3 is another exploded perspective view of the container as shown in FIG. 1.

FIG. 4 is a top cross-sectional view of the container as shown in FIG. 1.

FIG. 5 is a front cross-sectional view of the container as shown in FIG. 1.

FIG. 6 is a partially perspective view of the container as shown in FIG. 1.

FIG. 7 is a schematic operational view of the container as shown in FIG. 5.

FIG. 8 is a schematic operational view of the container as shown in FIG. 7.

FIG. 9 is an exploded perspective view of a container in accordance with another preferred embodiment of the present invention.

FIG. 10 is a front cross-sectional assembly view of the container as shown in FIG. 9.

### DETAILED DESCRIPTION OF THE INVENTION

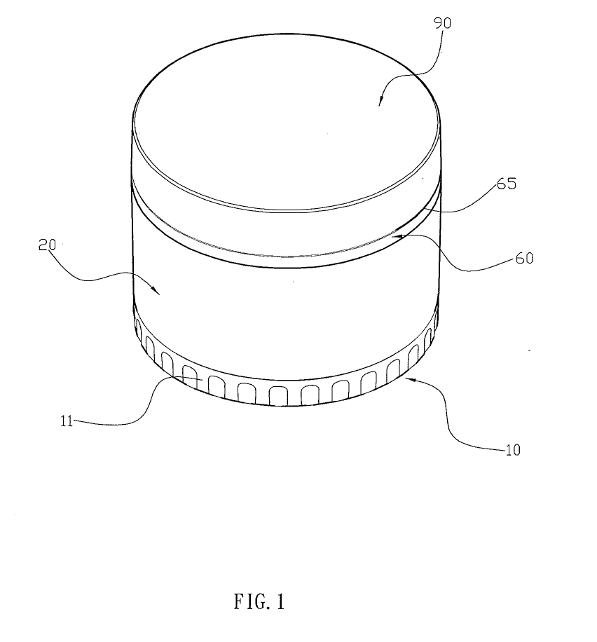

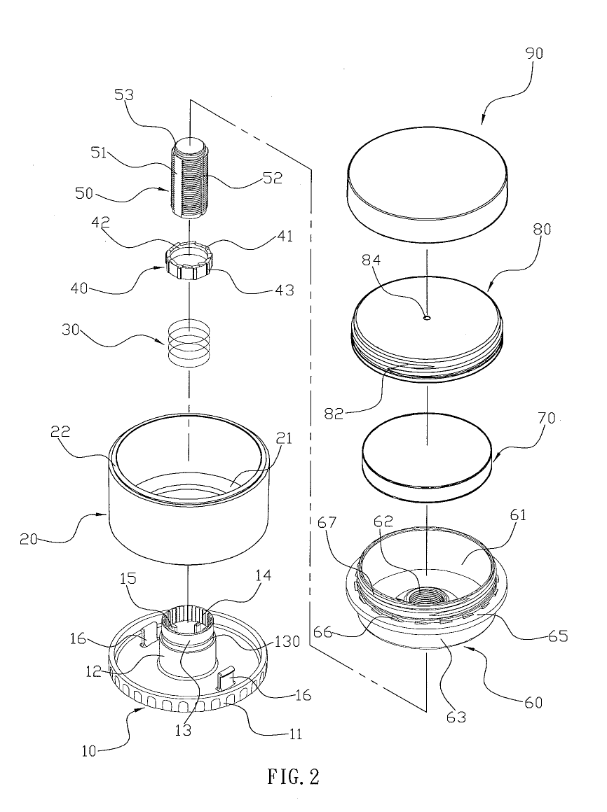

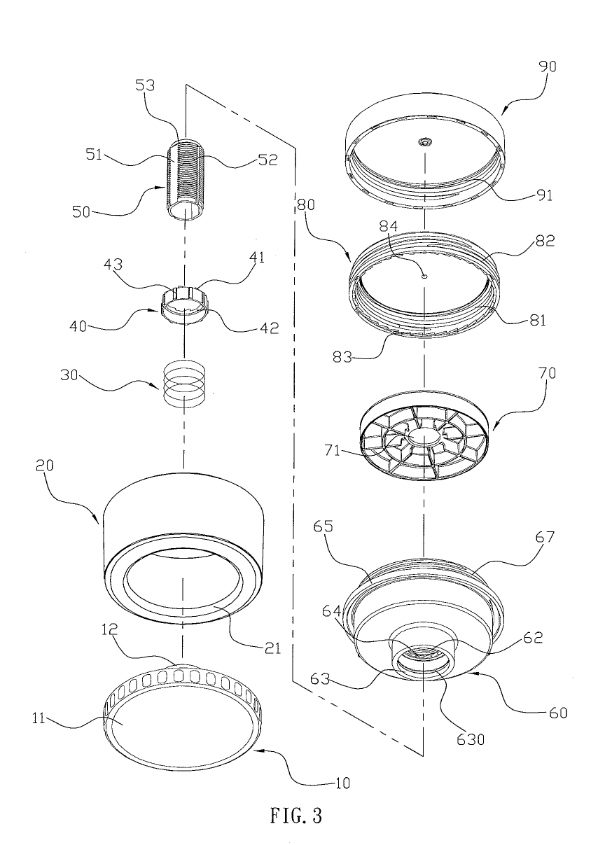

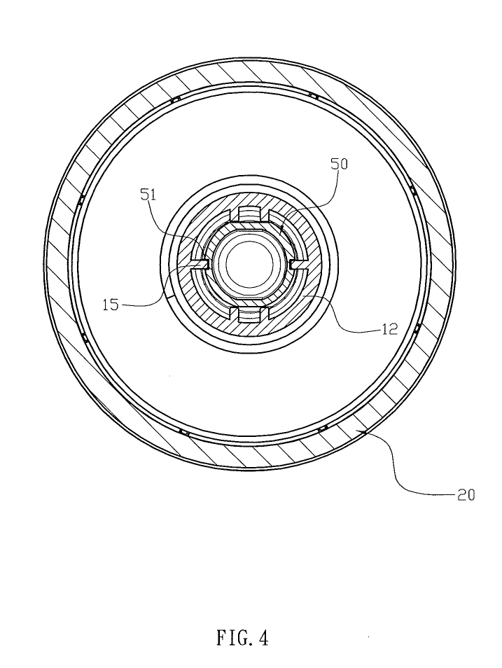

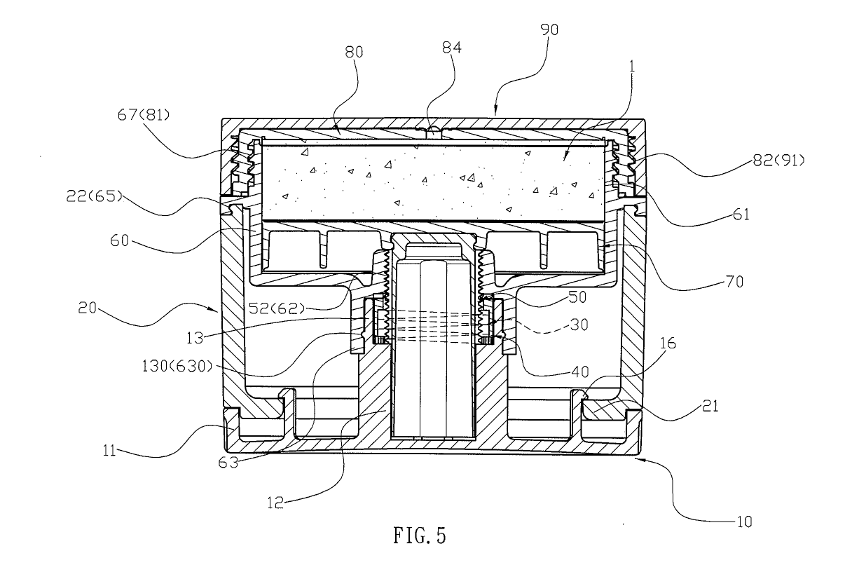

Referring to the drawings and initially to FIGS. 1-5, a container in accordance with the preferred embodiment of the present invention comprises a container body 20, a rotation seat 10 rotatably mounted on a bottom of the container body 20 and provided with a shaft tube 12 extending into the container body 20, a plurality of limit bars 15 mounted in the shaft tube 12 of the rotation seat 10, a threaded rod 50 movably mounted in the shaft tube 12 of the rotation seat 10 and having a periphery provided with an outer threaded portion 52 which has a plurality of limit slots 51 slidably mounted on the limit bars 15, an inner box 60 mounted on a top of the container body 20 and having an inner portion provided with a receiving chamber 61 which has a bottom provided with an inner threaded portion 62 screwed onto the outer threaded portion 52 of the threaded rod 50, a fixing cap 80 mounted on an open top of the inner box 60 to seal the receiving chamber 61 of the inner box 60 and having a surface provided with an outlet hole 84 connected to the receiving chamber 61 of the inner box 60, a piston 70 movably mounted in the receiving chamber 61 of the inner box 60 and connected with the threaded rod 50 to move in concert with the threaded rod 50 relative to the fixing cap 80, and an outer cover 90 mounted on the fixing cap 80 to cover the outlet hole 84 of the fixing cap 80.

The rotation seat 10 has a periphery provided with a rotation portion 11 abutting the bottom of the container body 20. The rotation seat 10 has a surface provided with two opposite locking hooks 16 each located between the shaft tube 12 and the rotation portion 11.

The shaft tube 12 is located at a central portion of the rotation seat 10. The shaft tube 12 has an inner wall having an upper portion provided with a plurality of axially extending locking grooves 14. The locking grooves 14 of the shaft tube 12 are located above the limit bars 15. The shaft tube 12 has an outer wall having an upper portion provided with a shoulder 13. The shoulder 13 of the shaft tube 12 has an outer wall provided with an annular retaining rib 130.

The container body 20 is a hollow cylinder. The top of the container body 20 has a periphery provided with a first retaining lip 22. The bottom of the container body 20 has a periphery provided with an annular flange 21 which extends radially and inwardly and is limited between the rotation portion 11 and the locking hooks 16 of the rotation seat 10.

The threaded rod 50 is movable axially in the shaft tube 12 and is extendable into the receiving chamber 61 of the inner box 60. The threaded rod 50 has an upper end provided with a connecting stud 53 extended into the receiving chamber 61 of the inner box 60.

The inner box 60 has a periphery provided with a retaining lip 65 which extends radially and outwardly and is snapped onto the first retaining lip 22 of the container body 20 so that the inner box 60 can be rotated relative to the container body 20 and cannot be detached from the container body 20. The retaining lip 65 of the inner box 60 has a surface provided with a plurality of first locking teeth 66. The inner box 60 has an upper end provided with an outer threaded section 67 located above the first locking teeth 66. The inner box 60 has a bottom provided with a mounting tube 63 mounted on the shoulder 13 of the shaft tube 12. The mounting tube 63 of the inner box 60 has a periphery provided with a plurality of first oneway ratchet teeth 64 and has an inner wall provided with an annular retaining groove 630 snapped onto the retaining rib 130 of the shoulder 13. The inner threaded portion 62 of the inner box 60 is located at a central portion of the receiving chamber 61.

The container further comprises a fixing ring 40 mounted in the shaft tube 12 of the rotation seat 10 and surrounding the threaded rod 50, and an elastic member 30 mounted in the shaft tube 12 of the rotation seat 10 and biased between the rotation seat 10 and the fixing ring 40 to push the fixing ring 40 toward the inner box 60. The fixing ring 40 has an outer wall provided with a plurality of axially extending locking ribs 43 locked in the locking grooves 14 of the shaft tube 12 and has an inner wall provided with a stepped stop edge 42 to stop the elastic member 30. The fixing ring 40 has a top provided with a plurality of second oneway ratchet teeth 41 engaging the first oneway ratchet teeth 64 of the inner box 60. The fixing ring 40 has an diameter greater than the diameter of the threaded rod 50 to allow passage of the threaded rod 50. The elastic member 30 has an upper end abutting the stop edge 42 of the fixing ring 40 and a lower end abutting the limit bars 15.

The piston 70 has a bottom having a central portion provided with a connecting ring 71 mounted on the connecting stud 53 of the threaded rod 50 to connect the piston 70 with the threaded rod 50.

The fixing cap 80 has a substantially inverted U-shaped circular body. The fixing cap 80 has an outer wall provided with an outer threaded segment 82 and has an inner wall provided with an inner threaded section 81 screwed onto the outer threaded section 67 of the inner box 60. The fixing cap 80 has a bottom provided with a plurality of second locking teeth 83 engaging the first locking teeth 66 of the inner box 60. The second locking teeth 83 of the fixing cap 80 are located under the inner threaded section 81. The outlet hole 84 of the fixing cap 80 is located at a central portion of the fixing cap 80.

The outer cover 90 has a substantially inverted U-shaped circular body. The outer cover 90 has an inner wall provided with an inner threaded segment 91 screwed onto the outer threaded segment 82 of the fixing cap 80.

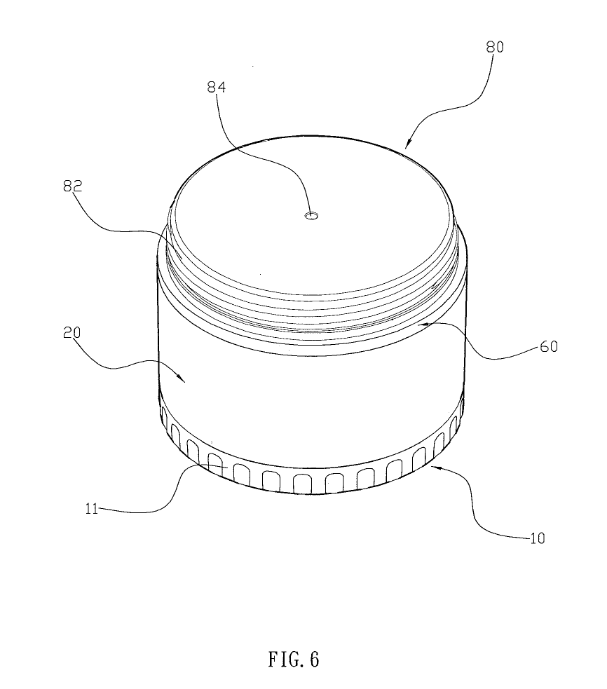

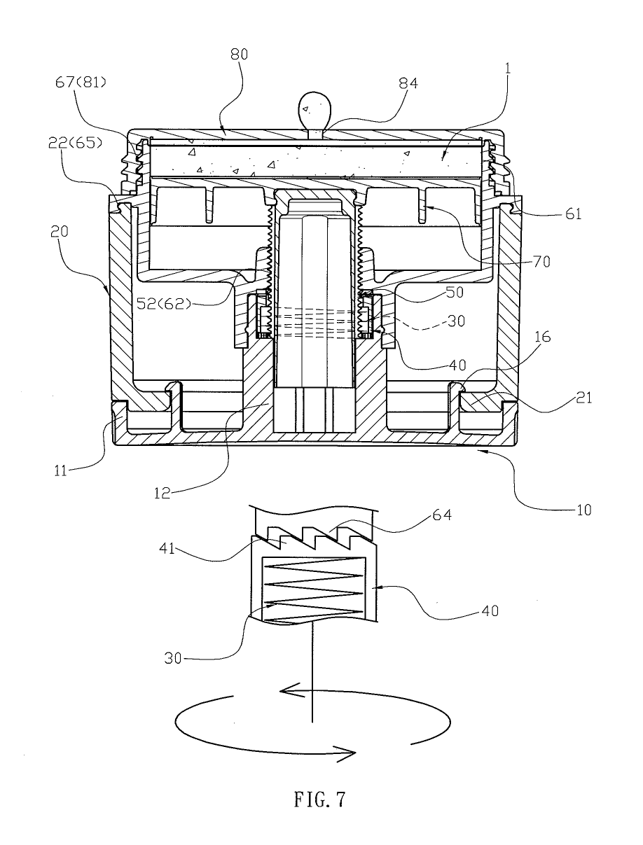

In operation, referring to FIGS. 6 and 7 with reference to FIGS. 1-5, the outer cover 90 is removed form the fixing cap 80 to expose the outlet hole 84 of the fixing cap 80 as shown in FIG. 6. When the rotation seat 10 is rotated relative to the container body 20 in the positive direction (the counterclockwise direction as shown in FIG. 7), the shaft tube 12 is rotated to drive the fixing ring 40, and the limit bars 15 are rotated to drive the threaded rod 50 so that the fixing ring 40 and the threaded rod 50 are rotated by rotation of the rotation seat 10. When the fixing ring 40 is rotated, the second oneway ratchet teeth 41 of the fixing ring 40 skip and pass the first oneway ratchet teeth 64 of the inner box 60 as shown in FIG. 7 so that the inner box 60 is kept stationary. At this time, the limit slots 51 of the threaded rod 50 are limited by the limit bars 15, and the inner threaded portion 62 of the inner box 60 are screwed onto the outer threaded portion 52 of the threaded rod 50 so that when the threaded rod 50 is rotated relative to the inner box 60 which is kept stationary, the limit slots 51 of the threaded rod 50 are moved on the limit bars 15, and the threaded rod 50 is moved upward in the inner threaded portion 62 of the inner box 60 to push the piston 70 toward the fixing cap 80 as shown in FIG. 7. In such a manner, the piston 70 is moved upward in the receiving chamber 61 of the inner box 60 to compress cream 1 filled between the fixing cap 80 and the receiving chamber 61 of the inner box 60 so that the cream 1 is squeezed outward from the outlet hole 84 of the fixing cap 80 for use with a user.

Accordingly, the cream 1 is compressed gradually by rotation of the rotation seat 10 so that a determined amount of cream 1 is squeezed outward from the outlet hole 84 of the fixing cap 80 to prevent the cream 1 from being squeezed too excessively and to prevent waste of the cream 1. In addition, the piston 70 is moved in the receiving chamber 61 of the inner box 60 to compress the cream 1 so that the space between the fixing cap 80 and the receiving chamber 61 of the inner box 60 is disposed at a vacuum state to prevent the cream 1 from contacting the ambient air so as to keep freshness and purity of the cream 1 in the receiving chamber 61 of the inner box 60. Further, the cream 1 is directly squeezed outward from the outlet hole 84 of the fixing cap 80 so that the user's hand will not directly touch the cream 1 to prevent the cream 1 from being contaminated. Further, the user only needs to rotate the rotation seat 10 to squeeze the cream 1 outward from the outlet hole 84 of the fixing cap 80 so that the container is operated easily and conveniently.

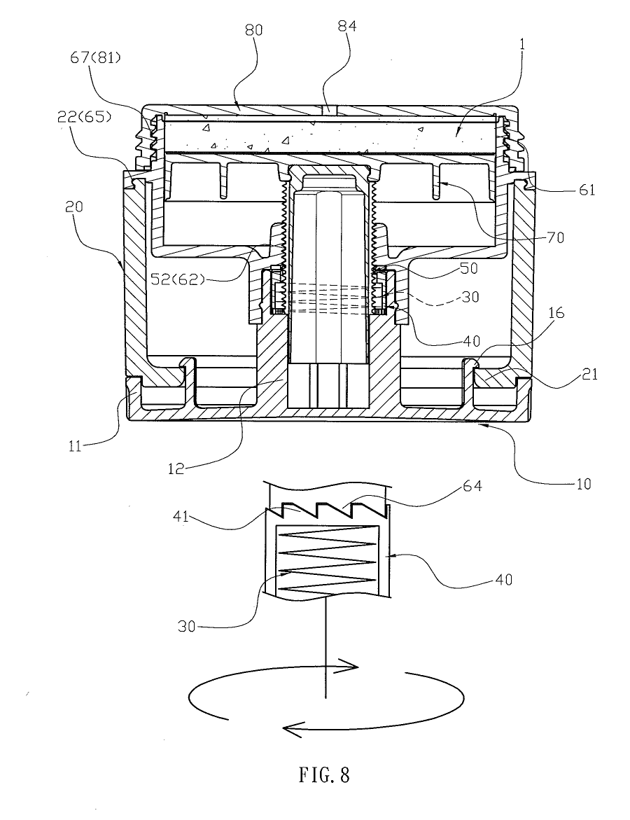

On the contrary, referring to FIG. 8 with reference to FIGS. 1-5, when the rotation seat 10 is rotated relative to the container body 20 in the reverse direction (the clockwise direction as shown in FIG. 8), the second one-way ratchet teeth 41 of the fixing ring 40 engage the first oneway ratchet teeth 64 of the inner box 60 so that the fixing ring 40, the threaded rod 50 and the inner box 60 are rotated in concert with the rotation seat 10 synchronously. In such a manner, the threaded rod 50 and the inner box 60 are rotated synchronously so that the threaded rod 50 stop moving in the inner threaded portion 62 of the inner box 60, and the piston 70 also stop moving in the receiving chamber 61 of the inner box 60. Thus, when the rotation seat 10 is rotated, the piston 70 is only moved forward and cannot be moved backward so that the piston 70 compresses the cream 1 successively to keep the space between the fixing cap 80 and the receiving chamber 61 of the inner box 60 at a vacuum state and to prevent the ambient air from being introduced into the receiving chamber 61 of the inner box 60.

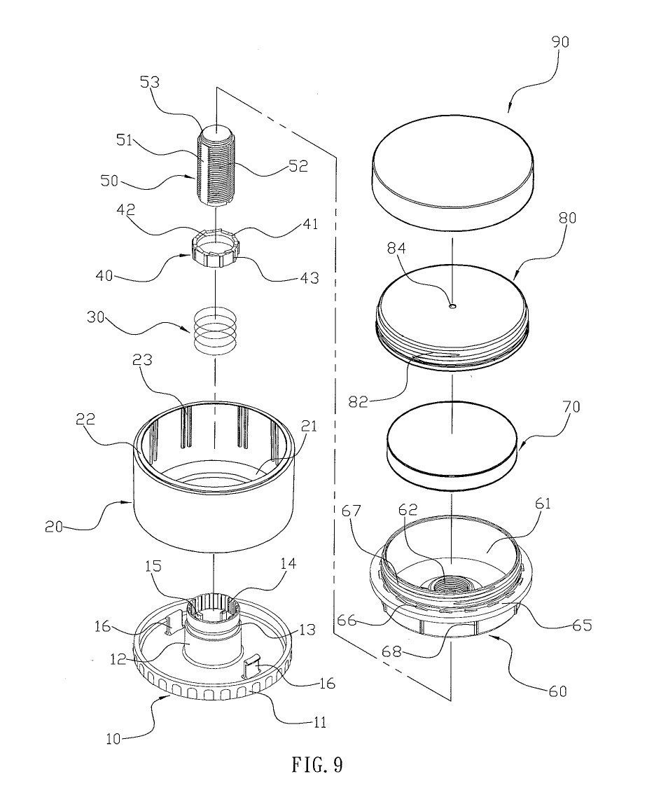

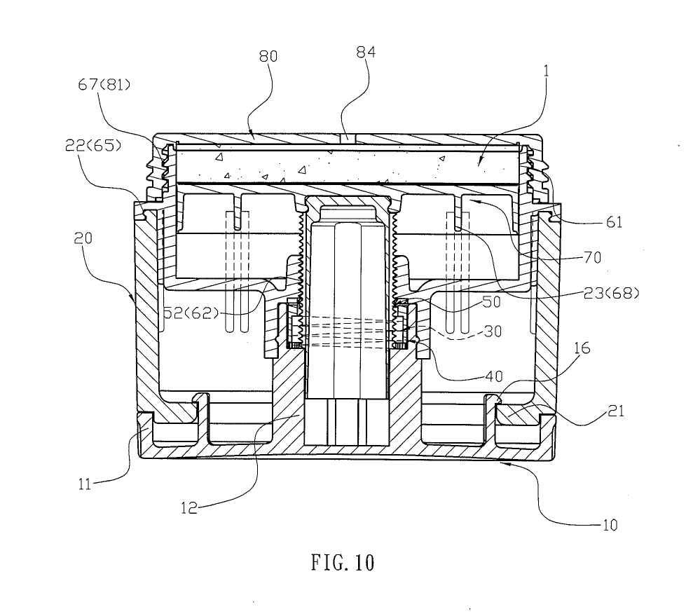

Referring to FIGS. 9 and 10, the container body 20 has an inner wall provided with provided with a plurality of axially extending limit channels 23, and the inner box 60 has a lower end having an outer wall provided with a plurality of axially extending limit blocks 68 mounted in the limit channels 23 of the container body 20 to lock the inner box 60 onto the container body 20.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A container, comprising:
a container body;
a rotation seat rotatably mounted on a bottom of the container body and provided with a shaft tube extending into the container body;
a plurality of limit bars mounted in the shaft tube of the rotation seat;
a threaded rod movably mounted in the shaft tube of the rotation seat and having a periphery provided with an outer threaded portion which has a plurality of limit slots slidably mounted on the limit bars;
an inner box mounted on a top of the container body and having an inner portion provided with a receiving chamber which has a bottom provided with an inner threaded portion screwed onto the outer threaded portion of the threaded rod;
a fixing cap mounted on an open top of the inner box to seal the receiving chamber of the inner box and having a surface provided with an outlet hole connected to the receiving chamber of the inner box;
a piston movably mounted in the receiving chamber of the inner box and connected with the threaded rod to move in concert with the threaded rod relative to the fixing cap, and an outer cover mounted on the fixing cap to cover the outlet hole of the fixing cap.

2. The container of claim 1, wherein
the rotation seat has a periphery provided with a rotation portion abutting the bottom of the container body;
the shaft tube has an inner wall having an upper portion provided with a plurality of axially extending locking grooves;
the shaft tube has an outer wall having an upper portion provided with a shoulder;
the threaded rod has an upper end provided with a connecting stud extended into the receiving chamber of the inner box;
the inner box has a bottom provided with a mounting tube mounted on the shoulder of the shaft tube;
the mounting tube of the inner box has a periphery provided with a plurality of first oneway ratchet teeth;
the container further comprises:
a fixing ring mounted in the shaft tube of the rotation seat and surrounding the threaded rod; and
an elastic member mounted in the shaft tube of the rotation seat and biased between the rotation seat and the fixing ring to push the fixing ring toward the inner box;
the fixing ring has an outer wall provided with a plurality of axially extending locking ribs locked in the locking grooves of the shaft tube;
the fixing ring has a top provided with a plurality of second one-way ratchet teeth engaging the first oneway ratchet teeth of the inner box;
the piston has a bottom provided with a connecting ring mounted on the connecting stud of the threaded rod to connect the piston with the threaded rod.

3. The container of claim 2, wherein
the fixing ring has an inner wall provided with a stepped stop edge to stop the elastic member;
the elastic member has an upper end abutting the stop edge of the fixing ring and a lower end abutting the limit bars;
the shaft tube is located at a central portion of the rotation seat;
the locking grooves of the shaft tube are located above the limit bars;
the shoulder of the shaft tube has an outer wall provided with an annular retaining rib;
the mounting tube of the inner box has an inner wall provided with an annular retaining groove snapped onto the retaining rib of the shoulder;
the container body is a hollow cylinder;
the threaded rod is movable axially in the shaft tube and is extendable into the receiving chamber of the inner box;
the inner threaded portion of the inner box is located at a central portion of the receiving chamber;
the fixing ring has an diameter greater than the diameter of the threaded rod to allow passage of the threaded rod;
the outlet hole of the fixing cap is located at a central portion of the fixing cap.

4. The container of claim 2, wherein
the rotation seat has a surface provided with two opposite locking hooks each located between the shaft tube and the rotation portion;
the bottom of the container body has a periphery provided with an annular flange limited between the rotation portion and the locking hooks of the rotation seat;
the top of the container body has a periphery provided with a first retaining lip;
the inner box has a periphery provided with a retaining lip snapped onto the first retaining lip of the container body so that the inner box can be rotated relative to the container body and cannot be detached from the container body;
the retaining lip of the inner box has a surface provided with a plurality of first locking teeth;
the inner box has an upper end provided with an outer threaded section located above the first locking teeth;
the fixing cap has an inner wall provided with an inner threaded section screwed onto the outer threaded section of the inner box;
the fixing cap has a bottom provided with a plurality of second locking teeth engaging the first locking teeth of the inner box;
the second locking teeth of the fixing cap are located under the inner threaded section;
the fixing cap has an outer wall provided with an outer threaded segment;
the outer cover has an inner wall provided with an inner threaded segment screwed onto the outer threaded segment of the fixing cap.

5. The container of claim 1, wherein
the container body has an inner wall provided with provided with a plurality of axially extending limit channels;
the inner box has a lower end having an outer wall provided with a plurality of axially extending limit blocks mounted in the limit channels of the container body to lock the inner box onto the container body.
